(19) United States
(12) Patent Application Publication
(10) Pub. No.: US 2005/0150465 A1
(43) Pub. Date: Jul. 14, 2005

(54) Adjustable sliding pet comb

(76) Inventors: Steven B. Dunn, Beverly Hills, CA (US); Bryce Fujii, Canoga Park, CA (US); Kevin Clark, Los Angeles, CA (US)

Correspondence Address: KNOBLE YOSHIDA & DUNLEAVY, LLC;Eight Penn Center, Suite 1350, 1628 John Kennedy Blvd., Philadelphia, PA, 19103, US

(21) Appl. No.: 10/757,243

(22) Filed: Jan. 14, 2004

(51) Int. Cl. A01K 13/00

(52) U.S. Cl. 119/601

(57) ABSTRACT

An article for grooming an animal includes a housing that has an outer gripping surface and a longitudinally extending grooming tool that is at least partially mounted within the housing for longitudinal sliding movement with respect to the housing. The longitudinally extending grooming tool, which in the preferred embodiment is a comb, may thus be adjusted to a desired position with respect to be gripping surface to make grooming the animal as convenient as possible. In a first position, the article is configured as a standard comb wherein the gripping surface is substantially centered with respect to the tines of the comb. In a second position, the tines of the comb are extended remotely away from the gripping surface, giving a user the advantage of leverage when using the comb.

### BACKGROUND OF THE INVENTION

1. Field of the Invention

This invention relates generally to the field of grooming products. More specifically, this invention relates to an article for grooming animals that is adaptable to perform a variety of different grooming tasks.

2. Description of the Related Technology

Pet grooming tools such as combs and brushes are made and marketed in a wide variety of different sizes and configurations. Each pet grooming tool design has certain advantages and disadvantages with respect to the others. One pet comb design, for example, may have an extended handle so that a person grooming the animal will be able to reach further and exert a certain amount of leverage during the grooming process. Another pet comb design may be more like a traditional comb, configured so that it has a gripping surface on the shank of the comb, which may be more suitable for close combing or the grooming of smaller animals where reach is not an issue. Many pet owners who are diligent about the grooming of their pets own several such different grooming implements.

Purchasing and storing unnecessary pet grooming tools is expensive and space consuming. A need exists for a pet grooming tool that is adaptable to perform a variety of different grooming tasks.

A need further exists for a pet grooming tool that is adapted to permit the consumer to choose different handle positions for different grooming techniques in order to minimize strain on their hands and wrists. This is particularly important for individuals who spend a significant amount of time using grooming tools, such as animal care professionals or pet owners who have several different pets.

### SUMMARY OF THE INVENTION

Accordingly, it is an object of the invention to provide a pet grooming tool that is adaptable to perform a variety of different grooming tasks. It is further an object of the invention to provide a pet grooming tool that is adapted to permit the consumer to choose different handle positions for different grooming techniques in order to minimize strains on their hands and wrists.

In order to achieve the above and other objects of the invention, an article for grooming an animal according to a first aspect of the invention includes a housing that has an outer gripping surface, and a longitudinally extending grooming tool. At least a portion of the longitudinally extending grooming tool is mounted within the housing for longitudinal sliding movement with respect to the housing. This permits a user to adjust the longitudinal position of the grooming tool with respect to the housing while continuously maintaining a grip on the outer gripping surface.

According to a second aspect of the invention, a method of grooming an animal includes steps of gripping an outer gripping surface of a grooming article that includes an elongated grooming tool; adjusting the elongated grooming tool to a desired longitudinal position with respect to the outer gripping surface while maintaining a grip on the outer gripping surface; and grooming the animal with the elongated grooming tool while gripping the outer gripping surface.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a side elevational view of a an article that is constructed according to a preferred embodiment of the invention, shown in a first operational position;

FIG. 2 is a front elevational view of the article that is depicted in FIG. 1; and

FIG. 3 is a side elevational view of the article that is shown in FIG. 1, depicted in a second operational position.

### DETAILED DESCRIPTION OF THE PREFERRED EMBODIMENT(S)

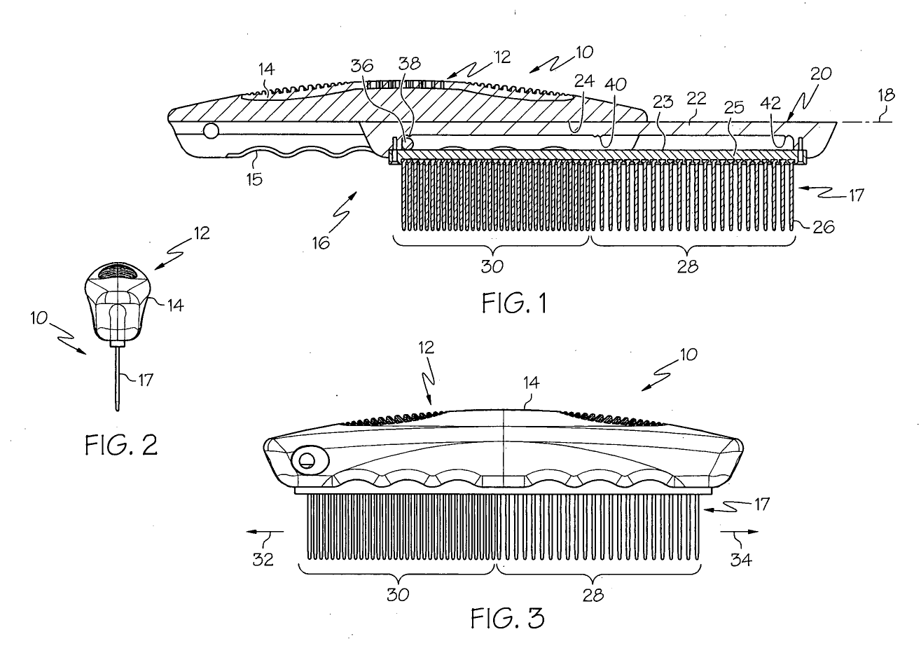

Referring now to the drawings, wherein like reference numerals designate corresponding structure throughout the views, and referring in particular to FIG. 1, an article 10 for grooming an animal according to a preferred embodiment of the invention includes a housing 12 that has an outer gripping surface 14 including a resilient textured grip portion 15 that is configured to accommodate a person's fingers when gripping the outer gripping surface 14. Grip portion 15 is preferably fabricated from a resilient elastomeric material. As is further shown in FIG. 1, article 10 further includes a longitudinally extending grooming tool 16 that is preferably embodied as a comb 17 that is elongated along an axis 18. Comb 17 includes a longitudinally extending shank portion 20 that has a guide rail 22 defined as an upper portion thereof. A guide slot 23 is defined between the guide rail 22 and a lower mounting rail 25 of the comb 17. The lower portion of the rail 22 has a first detent 38 provided in a leftmost area thereof, a second detent 40 defined in a second, center area thereof and a third detent 42 defined in a third, rightmost area of the guide rail 22. Comb 17 further includes a plurality of tines 26, each of which has one end that is rotatably mounted within the lower mounting rail 25 and extends substantially perpendicularly to the longitudinal axis 18. The ability of the tines 26 to rotate during use reduces pulls and snags during grooming. Comb 17 preferably has a length that is no greater than a length of the housing 12.

According to one important aspect of the invention, grooming tool 16 is mounted within the housing 12 for longitudinal sliding movement with respect to the housing 12. Specifically, guide rail 22 is mounted for sliding movement with respect to an internal guide track 24 that is longitudinally defined within the housing 12. As is shown diagrammatically in FIG. 3, the comb 17 may be adjustable to a retracted longitudinal position with respect to the housing 12 wherein the outer gripping surface 14 is substantially centered with respect to the plurality of tines 26. Alternatively, comb 17 may be adjusted to the position shown in FIG. 1, where the plurality of tines 26 are is substantially longitudinally offset from the housing 12 in an extended position. As is indicated by arrows 32, 34 in FIG. 3, comb 17 may be so extended in either direction, for purposes that will be described in greater detail below.

Referring again to FIG. 1, it will be seen that the article 10 includes a cam pin 36 that is attached to the housing 12 and is seated within the guide slot 23 of the comb 17. Cam pin 38 will be releasably locked into either of the first, second or third detents 38, 40, 42, to lock the comb 17 in the desired position with respect to the housing 12.

As may be seen in FIGS. 1 and 3, comb 17 is preferably configured so as to have a first, coarse group of tines 28 that are spaced from each other by a first distance and a second, fine group of tines 30 that are spaced from each other by a second distance that is less than the first distance. When the comb 17 is extended from the housing 12 to the position that a shown in FIG. 1, the cam pin 36 is locked into the first detent 38 and the first, coarse group of tines 28 are positioned distally with respect to the outer gripping surface 14, thereby permitting efficient use of the coarse portion of the comb 17. Similarly, when it is desired to use the finer group of tines 30, the comb 17 may be extended in the direction of arrow 32, as shown in FIG. 3, so that the finer tines are positioned so as to permit their most efficient use. In this position, the cam pin 36 will be locked into the third detent 42. Alternatively, the comb could be snapped into a centered position, wherein the cam pin 36 is locked in the second detent 40. In operation, a person who is grooming a pet will grip the outer gripping surface 14 of the article 10 and will adjust the position of the comb 17 to the desired longitudinal position with respect to the outer gripping surface 14. The person will then groom the animal as desired, repositioning the comb 17 with respect to be gripping surface 14 as is appropriate. This allows the user to effectively isolate the tines that they are actually using during the grooming operation to more effectively groom the dog. The design is ergonomically superior to conventional combs; it allows the consumer to choose the handle position for each combing techniques that is easiest on their hand and wrist. It will eliminate the need to switch combs to gain a comfortable hold.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. An article for grooming an animal, comprising:
a housing, said housing having an outer gripping surface; and
a longitudinally extending grooming tool, at least a portion of said longitudinally extending grooming tool being mounted within said housing for longitudinal sliding movement with respect to said housing, whereby a user may adjust the longitudinal position of the grooming tool with respect to said housing while continuously maintaining a grip on said outer gripping surface, wherein said grooming tool is adjustable in a first direction to a first extended longitudinal position with respect to said housing and said grooming tool is further adjustable in a second direction opposite said first direction to a second extended longitudinal position with respect to said housing.

2. An article for grooming an animal according to claim 1, wherein said longitudinally extending grooming tool comprises a comb having a longitudinal axis and a plurality of tines that extend substantially perpendicularly to said longitudinal axis.

3. An article for grooming an animal according to claim 2, wherein said comb has a length that is no greater than a length of said housing.

4. An article for grooming an animal according to claim 2, wherein said comb is adjustable to a retracted longitudinal position with respect to said housing wherein said outer gripping surface is substantially centered with respect to said plurality of tines.

5. An article for grooming an animal according to claim 4, wherein when said comb is in said first extended longitudinal position with respect to said housing said outer gripping surface is substantially longitudinally offset from said plurality of tines.

6. An article for grooming an animal according to claim 1, wherein said outer gripping surface is textured to facilitate a firm grip thereon.

7. An article for grooming an animal according to claim 6, wherein said outer gripping surface is fabricated from a resilient elastomeric material.

8. An article for grooming an animal according to claim 2, wherein said comb is configured to have a first coarse group of tines that are spaced from each other by a first distance and a second fine group of tines that are spaced from each other by a second distance that is less than said first distance.

9. An article for grooming an animal according to claim 8, wherein said comb may be adjusted in said first direction to said first extended longitudinal position with respect to said housing so as to permit efficient use of said first coarse group of tines, and wherein said comb may alternatively be adjusted in said second direction to second extended longitudinal position that is opposite from said first direction to permit efficient use of said second fine group of tines.

10. An article for grooming an animal according to claim 1, further comprising at least one predetermined stop position of longitudinal adjustment of said grooming tool with respect to said housing.

11. An article for grooming an animal according to claim 10, further comprising means for releasably positioning said grooming tool in said at least one predetermined stop position.

12. An article for grooming an animal according to claim 1, further comprising locking means for locking said longitudinally extending grooming tool in a desired position with respect to said housing.

13. An article for grooming an animal according to claim 1, wherein said longitudinally extending grooming tool comprises a comb having a shank portion and a plurality of tines, and wherein at least a portion of said shank portion is mounted for longitudinal sliding movement within said housing while said tines are positioned externally of said housing so as to be available for grooming use.

14. An article for grooming an animal according to claim 2, wherein said tines are rotatably mounted with respect to said comb.

15. A method of grooming an animal, comprising steps of:
(a) gripping an outer gripping surface of a grooming article that includes an elongated grooming tool, wherein said elongated grooming tool is adjustable in a first direction to a first extended longitudinal position with respect to said outer gripping surface and in a second direction opposite said first direction to a second extended longitudinal position with respect to said outer gripping surface;
(b) adjusting the elongated grooming tool to a desired longitudinal position with respect to the outer gripping surface while maintaining a grip on the outer gripping surface; and
(c) grooming the animal with the elongated grooming tool while gripping the outer gripping surface.

16. A method of grooming an animal according to claim 15, wherein said elongated grooming tool comprises a comb having a longitudinally extending shank portion and a plurality of tines that extend substantially perpendicularly with respect to said longitudinally extending shank portion.

17. A method of grooming an animal according to claim 16, wherein step (b) is performed by adjusting the comb so that said plurality of tines are substantially centered with respect to the outer gripping surface.

18. A method of grooming an animal according to claim 16, wherein step (b) is performed by adjusting the comb so that said plurality of tines are longitudinally offset from the outer gripping surface.

19. A method of grooming an animal according to claim 16, wherein said comb further has a first coarse group of tines that are spaced from each other by a first distance and a second fine group of tines that are spaced from each other by a second distance that is less than said first distance, and wherein step (b) is performed by moving said elongated grooming tool in said first direction to said first extended longitudinal position wherein said first coarse group of tines are longitudinally offset from said outer grip portion more than said second fine group of tines are longitudinally offset from said outer grip portion.

20. A method of grooming an animal according to claim 16, wherein said comb further has a first coarse group of tines that are spaced from each other by a first distance and a second fine group of tines that are spaced from each other by a second distance that is less than said first distance, and wherein step (b) is performed by moving said elongated grooming tool in second direction to said second extended longitudinal position wherein said second fine group of tines are longitudinally offset from said outer grip portion more than said first coarse group of tines are longitudinally offset from said outer grip portion.

21. A method of grooming an animal according to claim 15, wherein step (b) is performed by positioning the elongated grooming tool in a predetermined stop position with respect to the outer gripping surface.

22. A method of grooming an animal according to claim 15, further comprising a step of locking the elongated grooming tool in the selected position after the adjustment that is performed in step (b).

23. An article for grooming an animal, comprising:
a housing, said housing having an outer gripping surface and an inner gripping surface, wherein said inner gripping surface is contoured; and
a longitudinally extending grooming tool, at least a portion of said longitudinally extending grooming tool being mounted within said housing for longitudinal sliding movement with respect to said housing, whereby a user may adjust the longitudinal position of the grooming tool with respect to said housing while continuously maintaining a grip on said outer gripping surface, wherein said grooming tool is adjustable in a first direction to a first extended longitudinal position with respect to said housing and said grooming tool is further adjustable in a second direction opposite said first direction to a second extended longitudinal position with respect to said housing, wherein in movement to said first extended longitudinal position or said second longitudinal position permits access to said inner gripping surface.

24. An article for grooming an animal according to claim 23, wherein said longitudinally extending grooming tool comprises a comb having a longitudinal axis and a plurality of tines that extend substantially perpendicularly to said longitudinal axis.

25. An article for grooming an animal according to claim 24, wherein said tines are rotatably mounted with respect to said comb.

26. An article for grooming an animal according to claim 23, further comprising at least one predetermined stop position of longitudinal adjustment of said grooming tool with respect to said housing.

27. An article for grooming an animal according to claim 24, further comprising means for releasably positioning said grooming tool in said at least one predetermined stop position.
